(19) United States
(12) Patent Application Publication
(10) Pub. No.: US 2008/0046490 A1
(43) Pub. Date: Feb. 21, 2008

(54) Intelligent Sticky Notes

(75) Inventors: Lyndsay Williams, Cambridge (GB); Alex Taylor, Cambridge (GB)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/464,791

(22) Filed: Aug. 15, 2006

(51) Int. Cl. B43K 29/093; G06F 3/033

(52) U.S. Cl. 708/107; 345/179

(57) ABSTRACT

A user interface is described which includes electrical connections arranged in a pattern on a writing surface. An input is made by a user by drawing lines on the writing surface using a pencil or pen with conductive ink so as to electrically connect together two or more of the electrical connections.

### BACKGROUND

There are many ways in which someone can create a reminder for a task that needs to be done or a future appointment. Sticky notes are commonly used for reminders because they are easy to use and can be used in many different ways. Details of the appointment/task can be written on the note and then the note can be stuck in a particular location where it will be seen and therefore act as a reminder (e.g. around a person's computer monitor, on the exit door to their home, on the bathroom mirror etc).

Electronic diaries are commonly used to remind users of events and appointments. These diaries may run as applications on many different devices such as mobile phones, personal digital assistants (PDAs), computers (e.g. Microsoft Outlook (trade mark)) etc. Electronic diaries often have a reminder noise associated with the reminder e.g. a bleep or chime, which may be played at the same time as the reminder alert is displayed.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A user interface is described which includes electrical connections arranged in a pattern on a writing surface. An input is made by a user by drawing lines on the writing surface using a pencil or pen with conductive ink so as to electrically connect together two or more of the electrical connections.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIGS. 1A and 1B show two schematic diagrams of a user interface which enables the setting of a time by a user;

FIG. 2 shows a block diagram of an electrical circuit which includes the user interface shown in FIGS. 1A and 1B;

FIG. 3 shows another schematic diagram of a user interface;

FIG. 4 shows a schematic diagram of a user interface which includes a digital clock face;

FIG. 5 shows two examples of a means for indicating AM/PM;

FIG. 6 shows user interface comprising a calendar grid;

FIG. 7 shows a diagram of an intelligent sticky note;

FIG. 8 shows a schematic representation of a circuit diagram for an intelligent sticky note;

FIG. 9 shows an example flow diagram of a method of operation of the microcontroller shown in FIG. 8;

FIG. 10 shows a diagram of a second example intelligent sticky note;

FIG. 11 shows a schematic representation of a second example circuit diagram for an intelligent sticky note;

FIGS. 12A and 12B show alternative arrangements of parts of FIG. 11;

FIG. 13 shows an example flow diagram of a method of operation of the processor shown in FIG. 11;

FIG. 14 shows a schematic diagram of intelligent packaging

FIG. 15 shows a schematic diagram of a time clock interface;

FIG. 16 shows a schematic representation of a circuit diagram for a time clock interface;

FIG. 17 is a schematic diagram of part of a touch sensitive user interface; and

FIG. 18 is a diagram showing the measurements of a pencil track.

### Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

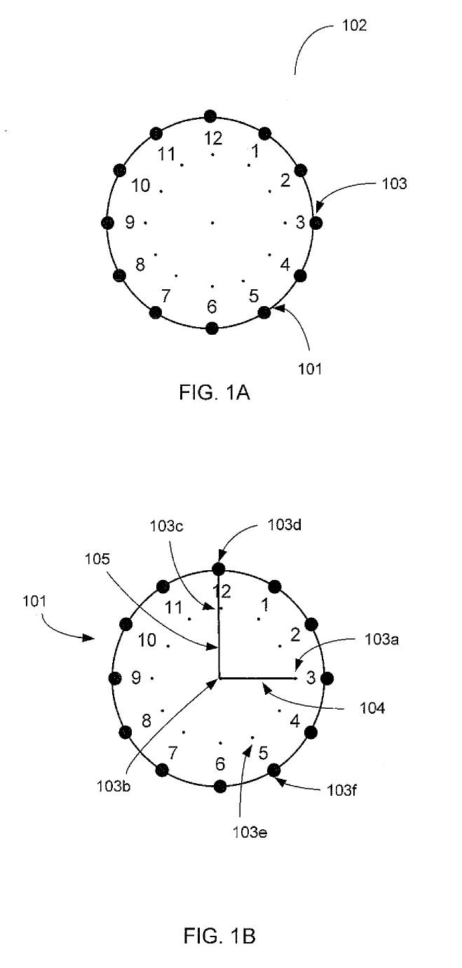

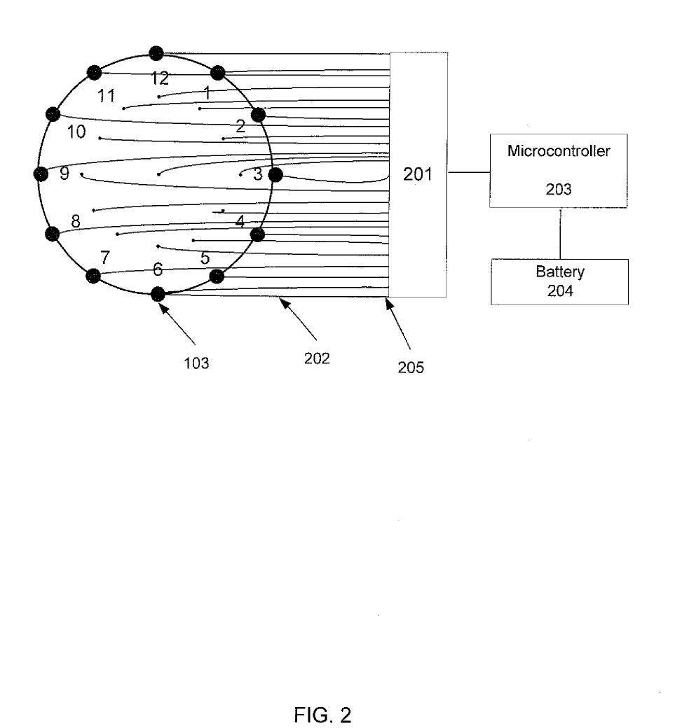

FIGS. 1A and 1B show two schematic diagrams of a user interface which enables the setting of a time by a user. This time may be used as an input to a processor (as shown in FIG. 2) and may indicate the time that a reminder is required or a time that an action is to be initiated (e.g. a video recorder to start recording a television program). The user interface comprises a clock face 101 which may be printed or otherwise produced on a surface 102. Arranged around the clock face are a number of electrical connection points 103. The time is set by the user by drawing on the surface with a pencil (e.g. using graphite as the writing medium) or writing implement with conductive ink (e.g. ink containing copper, carbon or silver particles) to display the time required i.e. by drawing in the hands of the clock. The lines drawn provide both a visual indication of the time and an electrical connection between some of the electrical connection points 103 because the graphite or conductive ink path is electrically conductive. Where a pencil, or other erasable medium is used, errors may be corrected or the user interface may be re-used by erasing the lines drawn (e.g. using a standard pencil eraser) and drawing new lines. As shown in FIG. 1B a time of 3 o'clock has been set by drawing hands on the clock face 101 and the lines drawn 104, 105 (which form the hands of the clock) connect several electrical connection points 103a-d.

FIG. 2 shows a block diagram of an electrical circuit which includes the user interface shown in FIGS. 1A and 1B. Each of the electrical connections 103 which are arranged around the clock face 101 are connected to a multiplexer 201 via an electrical track 202. The multiplexer 201 is connected to a microcontroller 203 (or other processor) which is powered by a battery 204. The microcontroller 203 may cycle through each connection 205 to the multiplexer to determine which of the electrical connection points 103 are connected together or any other suitable technique may be used. The determination of which electrical connection points are connected together may involve measurement of resistance, capacitance, inductance or any other suitable parameter. By determining which points are connected together, the microcontroller can determine what time has been set on the clock by the user, for example:

| Time | Points connected to point 103b |
|---|---|
| 12 o′clock | 103c, 103d |
| 3 o′clock | 103a, 103c, 103d |
| 3.25 | 103a, 103e, 103f |
| 5 o′clock | 103c, 103d, 103e |

The granularity with which the time may be set on the clock face 101 is determined, in this example, by the arrangement of the electrical connections. In the example, given, the time may be set to the nearest 5 minutes as the electrical connections are spaced at 5 minute intervals on the outer ring of connections (for the ‘long hand’ of the clock), with the hour being indicated by the inner ring of connections (the ‘short hand’). This provides a simple arrangement of connections, however, it means that the ‘short hand’ has to point to the hour for all minutes past that hour rather than being placed in the correct intermediate position between hours.

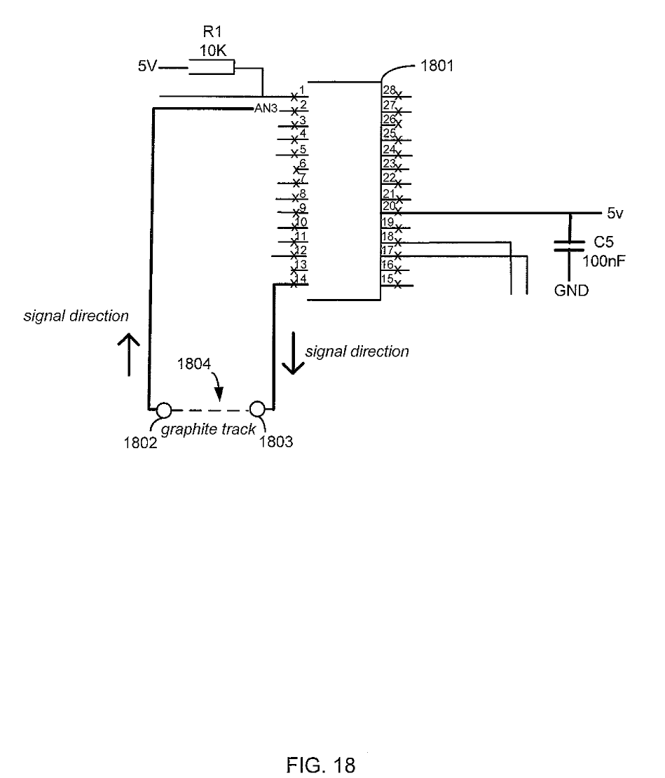

The multiplexer input (e.g. to multiplexer 201) may be an analogue or a digital signal. As the voltage out of the multiplexer 201 will be reduced by the resistance of the graphite mark (e.g. 20 k to 200 kohms), the analogue to digital converter of the microcontroller may used to read this voltage rather than a digital input. An example of a suitable microcontroller is shown in FIG. 18 and described below.

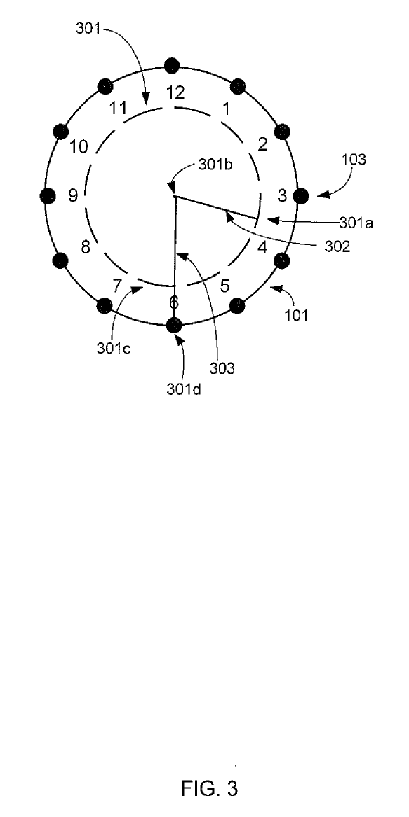

FIG. 3 shows another schematic diagram of a user interface which comprises a clock face 101 and an outer ring of electrical connection points 103 arranged every 5 minutes. The inner ring of electrical connection points, however, differs from that shown in FIGS. 1A, 1B and 2 in that the points have been replaced by line connections 301 which are short arcs and enable the time to be drawn in the simplistic fashion as described above or in a more correct manner. As shown in FIG. 3, lines 302, 303 have been drawn to indicate the time of 3:30 and these lines electrically connect connection points 301a-d. It will be appreciated that FIGS. 1-3 show examples of the arrangement of electrical connection points and other arrangements (or patterns) may alternatively be used (e.g. the central connection 103b, 301 b may be omitted).

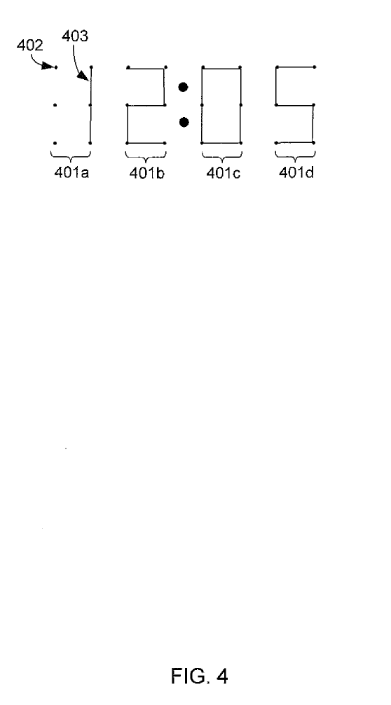

FIGS. 1-3 show an analog clock face, however, the user interface may alternatively (or in addition) have a digital clock face for setting a time, for example using the standard seven segments as shown in FIG. 4. FIG. 4 shows an arrangement of four sets 401a-d of six electrical connection points 402 which enables a user to write in the time in the form of digits by connecting the points with lines 403. In the example of FIG. 4, the lines indicate a time of 12.05. Each electrical connection point 402 may be connected to a multiplexer which is part of an electrical circuit similar to that shown in FIG. 2 and described above.

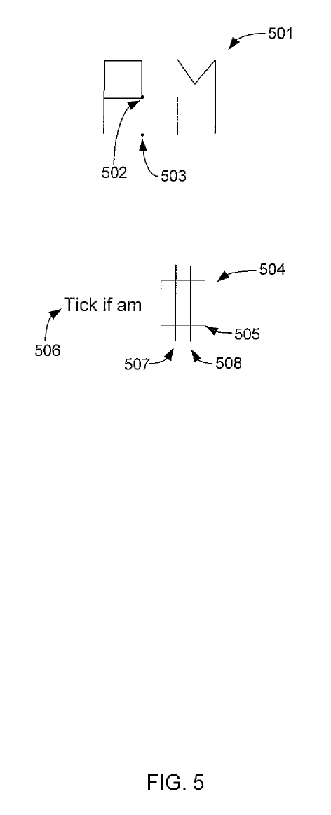

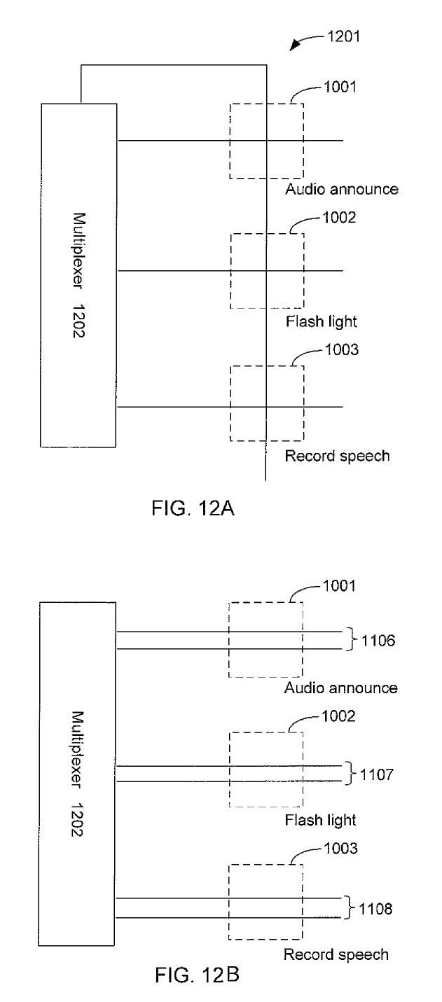

The digital clock face shown in FIG. 4 enables the user to set a time in the 24 hour clock whilst the analog clock face of FIGS. 1-3 only enables use of the 12 hour clock. Consequently it may be necessary in some applications to include a means by which the user can indicate whether the time drawn on the clock face relates to AM or PM. FIG. 5 shows two examples of a means for indicating AM/PM. In a first example, 501, the digits ‘PM’ may be shown next to an analog clock face with two electrical connection points 502, 503. By connecting the two connection points using a pencil or pen with conductive ink, the user changes the digits from ‘PM’ to ‘AM’ and the electrical connection can be detected by a connected processor (e.g. microcontroller 203 of FIG. 2). In a second example 504, a printed box 505 may be provided along with instructions 506 to the user to tick the box for AM (or PM, as specified). Two electrical connection lines 507, 508 are arranged such that if the user puts a tick in the box 505 the two lines will be electrically connected and again, this may be detected by a connected processor. In the example shown in FIG. 5 the two electrical connection lines are shown parallel and close to each other, however alternative arrangements may alternatively be used (e.g. perpendicular lines as shown in FIG. 12A). The electrical connection lines may comprise a single exposed electrical connection in the shape of a line or a plurality of exposed electrical connection points, which may be in the form of short lines. Again the lines drawn by the user provide both a visual indication and an electrical connection which can be detected by a processor.

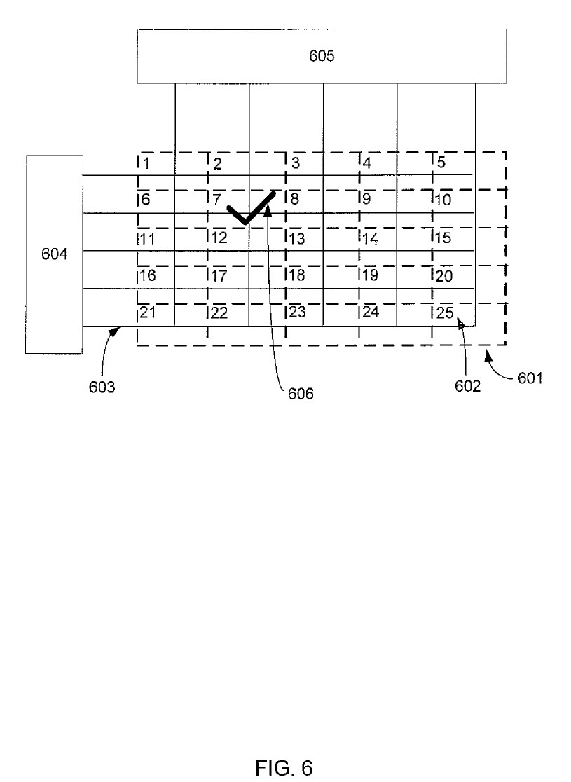

In addition to, or instead of, setting a time, the techniques described above may be used to set a date as shown in FIG. 6. FIG. 6 shows user interface comprising a calendar grid 601 with a box for each day. This grid may be printed or otherwise produced on a surface and may include numbers/words 602 to label each box of the grid. The user interface also comprises a matrix of connections 603 arranged in a similar manner to a standard keyboard matrix such that the connections do not touch where they appear to cross. As described above, the electrical connection lines may comprise a single exposed electrical connection in the shape of a line or a plurality of exposed electrical connection points, which may be in the form of short lines. The connections connect to a multiplexer 604 (for the horizontal connections), 605 (for the vertical connections) and these are connected to a processor (not shown). By marking a box using a pencil or pen with conductive ink, the line 606 electrically connects one of the vertical connections to one of the horizontal connections and by cycling through each of one of the set of connections (e.g. by cycling through the horizontal connections) the processor can determine whether a connection is connected to any of the other set of connections (e.g. any of the vertical connections) and from this information can determine what date has been indicated on the calendar grid (e.g. connection of the second horizontal connection to the second vertical connection indicating day 7 in the example of FIG. 6).

In some examples, a user may be permitted to indicate more than one date on the calendar grid at the same time. In order that the multiple dates can be distinguished, the electrical circuit may include diodes on each of the connections, as is known for a keyboard matrix. These diodes may be integrated within the multiplexers.

Where the same grid is used for more than one month (e.g. a standard grid which could be for any month), the grid may be accompanied by tick boxes or other means (e.g. seven segment elements) by which the month can be indicated using one or more lines written using a pencil or pen with conductive ink. Similar means may be provided to enable a user to indicate a required year or to make any other selection e.g. selection of one of a specified set of reminder times (e.g. 09:00, 12:00 and 16:00).

The arrangement of connections in FIG. 6 uses multiplexing to reduce the overall number of connections required, (i.e. there is not a separate connection between each connection point on the grid and the multiplexer). This principle may also be applied to the connections shown in the other examples (e.g. to reduce the number of connections 202 shown in FIG. 2).

The user interfaces described above are easy and intuitive to use and don't require the user to read an instruction manual. This may be particularly beneficial for applications where the users may be children, the elderly or individuals suffering from memory loss.

The user interface described above and shown in the examples of FIGS. 1-6 may be used in many different applications where a user is required to indicate a time and/or date, e.g. setting reminders, time clocks etc and a number of applications of the user interface are described in more detail below. The user interface may further comprise additional tick boxes (e.g. as shown in FIG. 5) or other elements and examples of such additional elements are described below. It will be appreciated that any elements of the user interface may be combined in any manner and not just in the particular combinations shown in the examples provided herein.

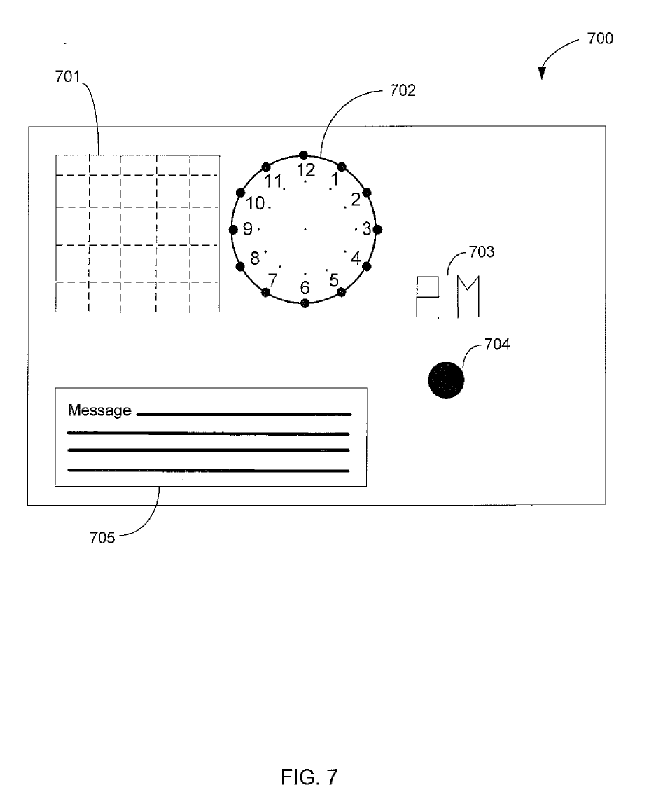

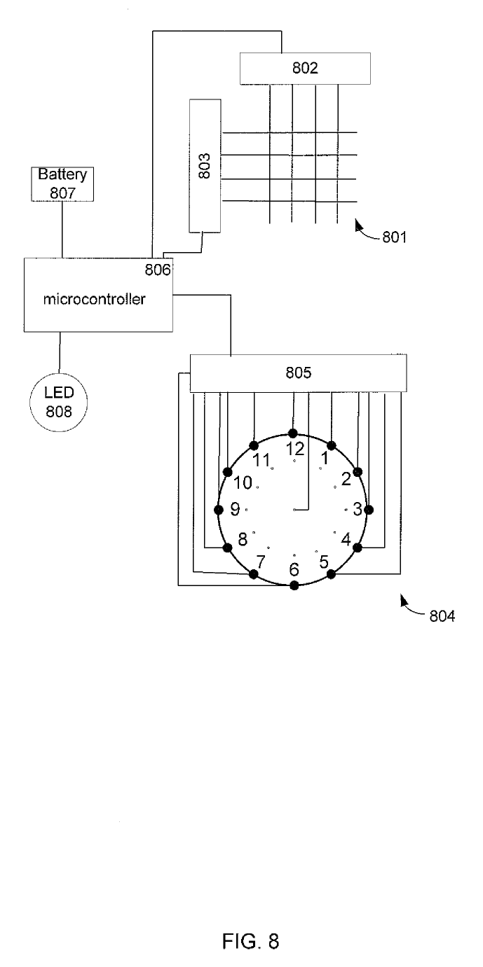

FIG. 7 shows a diagram of an intelligent sticky note 700 (also referred to as ‘SensePaper’) comprising a calendar grid 701, a clock face 702, an AM/PM indicator 703, an LED 704, and a message area 705. The calendar grid 701, clock face 702 and AM/PM indicator 703 may be as described above and shown in FIGS. 1-6. FIG. 8 shows a schematic representation of a circuit diagram 800 for an intelligent sticky note which comprises a matrix of connections 801 for the calendar grid (as shown in FIG. 6) connected to two multiplexers 802, 803 and a plurality of connections 804 for the clock face connected to a multiplexer 805. The matrix of connections 801 for the calendar grid and the plurality of connections 804 for the clock face are shown in simplified form for explanation purposes only. For example the plurality of connections 804 for the clock face shows only those for setting the minutes and a second set of connections arranged on an inner ring for the hours may also be provided, as described above and shown in FIGS. 1-3. The multiplexers 802, 803, 805 are connected to a microcontroller 806 (or other processor). The microcontroller 806 is powered by a battery 807 and is also connected to a LED 808.

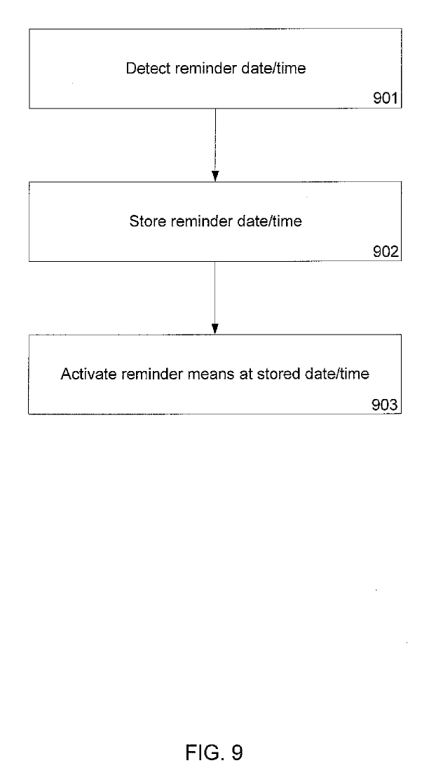

To use the intelligent sticky note 700, a user indicates the required reminder time and/or date using the calendar grid 701, clock face 702 and AM/PM indicator 703 in a manner as described above and may write a reminder message in the message area 705. The operation of the microcontroller 806 is as shown in FIG. 9. The microcontroller 806 detects the reminder date/time (step 901) e.g. by iterating through the connections to each multiplexer 802, 803, 805 to detect which contacts have been connected by lines drawn by a user and from this determining the date/time (e.g. using a look-up table, as shown above, or algorithm). This detection process may occur periodically (e.g. every five minutes) or quasi-continuously so that new marks made by the user or corrections to marks made by the user are detected. Having detected the date/time, this reminder date/time may be stored (step 902) in memory which is integral to the microcontroller 806 or in a separate memory element (not shown in FIG. 8) and the reminder means (e.g. LED 704, 808) is activated at the stored date/time (step 903) e.g. the LED is illuminated constantly or such that it flashes. A user's attention will be drawn to the intelligent sticky note because of the reminder means.

The intelligent sticky note 700 includes a single reminder means—LED 704. The LED may, in some examples, be part of a backlit display (such as that available from RS Components Ltd). In an example, the message area 705 may overlap (or be substantially aligned with) the backlit display, such that the message is written on the backlit display or on a transparent surface over the display. In such an example, the user's attention will be drawn to the intelligent sticky note and to the message area in particular by the illumination of the backlit display at the stored date/time.

In other examples, different reminder means may be included (in addition to or instead of the LED), such as a loudspeaker (e.g. a flat piezo speaker) or other noise generation means. The loudspeaker may be used to play a predetermined sound (e.g. beeps, a chime etc) or the intelligent sticky note may include a microphone to enable a user to record their own sound to be played at the reminder time. The sound recorded may in some cases be the reminder and therefore the message area may not be required or may not be used by a user. The loudspeaker may also be used to provide audible feedback of the time set (e.g. using a speech synthesizer and providing the audible message “a reminder has been set for 3:30”) or audible confirmation that a reminder has been set (e.g. a confirmation beep).

An intelligent sticky note, such as that shown in FIG. 7, (or any other application of the user interface described herein) may comprise one or more of the following:
a tick box (similar to tick box 504 shown in FIG. 5) to indicate that the reminder has been completed. This may cause the reminder means (e.g. LED, buzzer etc) to stop.
an identifier, such as a barcode, a serial number or RFID (radio frequency identification) tag. The identifier may be used to link the sticky note with a record or file on a computer e.g. to a calendar entry, a document etc. This may be particularly beneficial where data is transferred between the sticky note and a computer (see below).
a wireless receiver, to enable data to be uploaded from a computer to the sticky note, such as a sound file to be played at the reminder time or further information on the reminder (e.g. for display on an LED display, see below). This receiver may use any wireless technology such as RF (e.g. Bluetooth, Wifi), infra-red etc.
a wireless transmitter, to enable the reminder time and any other data to be transmitted to a computer (e.g. the sound recorded using a microphone integrated into the sticky note). This transmitter may use any wireless technology such as RF, infra-red etc. It will be appreciated that the transmitter and receiver may use the same or different wireless technology and may be integrated in the form of a transceiver.
an LED display, to display data uploaded from a computer via the wireless receiver.
means for selecting the reminder type required (e.g. audible and/or visible reminder), such as one or more tick boxes. It may also be possible to select further aspects of the audible/visible reminder e.g. LED color, sound file, noise type etc.
   Where the note includes a transmitter and receiver, the note may be integrated with an electronic diary (such as Microsoft Outlook (trade mark)) using the identifier for the particular sticky note. For example, information relating to the sticky note may be synchronized with the calendar.

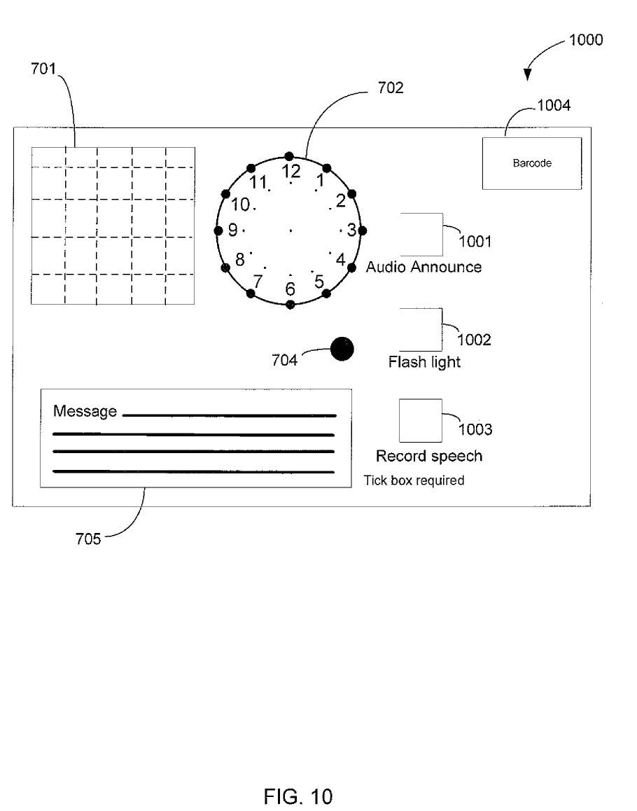

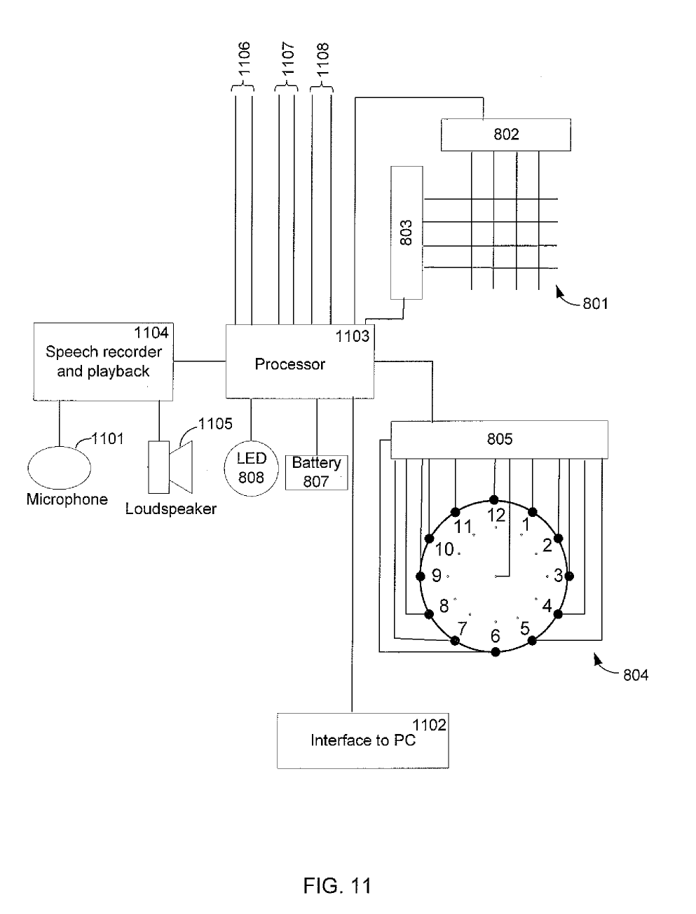

FIG. 10 shows a schematic diagram of a second example intelligent sticky note 1000 and FIG. 11 shows a corresponding circuit diagram. The intelligent sticky note 1000 comprises a calendar grid 701, clock face 702, LED 704 and message area 705. The sticky note also has two tick boxes 1001, 1002 for selection of the reminder type (an audio announcement and/or a flashing LED) and a tick box 1003 for recording speech via the integrated microphone 1101 (not visible in FIG. 10). The sticky note also includes a barcode 1004 which uniquely identifies the note and the ID of the note may be used in communication with a computer via an interface to a PC 1102 (not visible in FIG. 10). The interface 1102 may be wireless and may have transmitting and/or receiving capabilities. The corresponding circuit diagram of FIG. 11 comprises a processor 1103 which is connected to a first arrangement of electrical connections 801 for the calendar grid 701 via two multiplexers 802, 803 and a second arrangement of electrical connections 804 for the clock face 702 via a multiplexer 805. As in FIG. 8, the first and second arrangements of electrical connections 801, 804 are shown in simplified form for explanation purposes only. The processor 1103 is powered by a battery 807 and is also connected to an LED 808 and a speech recorder and playback element 1104 (such as the ChipCorder (trade mark) from Winbond (trade mark)) which has an associated microphone 1101 and loudspeaker 1105. The processor is also connected to an interface to the PC 1102 and to three pairs of connections 1106-1108 which are for the tick boxes 1001-1003 (e.g. in a similar arrangement to that shown in FIG. 5).

It will be appreciated that the arrangement of connections shown in FIG. 11 is by way of example only and the connections may be arranged in different ways to achieve the same effect. For example, the tick boxes 1001-1003 may be implemented using a matrix 1201 (as shown in FIG. 12A) similar to that used for the calendar grid 801 (and shown in more detail in FIG. 6) or the pairs of connections may be connected to a multiplexer 1202 (as shown in FIG. 12B) which is in turn connected to the processor 1103. In another example, the tick boxes and the calendar grid may be implemented using a single matrix similar to that shown in FIG. 6.

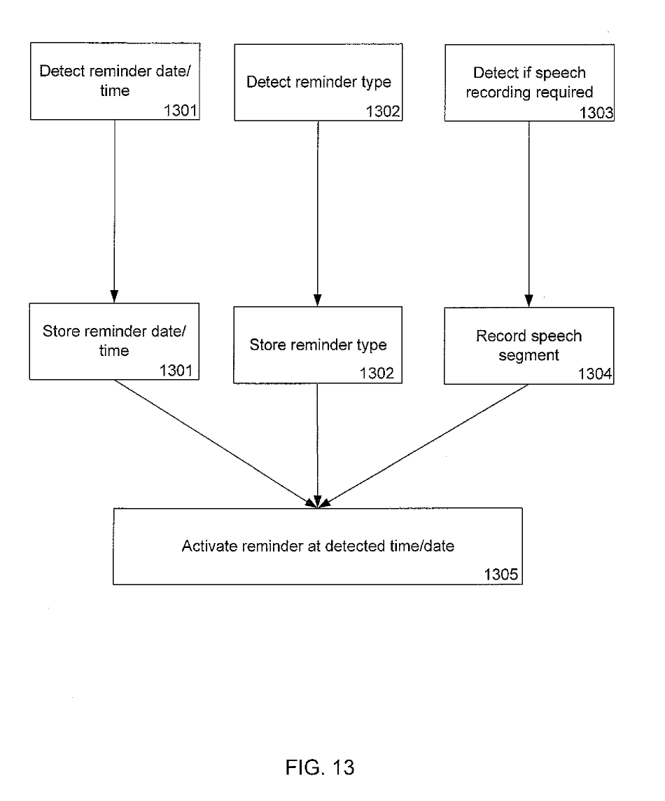

The operation of the processor 1103 is as shown in FIG. 13. The processor detects the reminder date/time (step 1301, e.g. as described above), the reminder type (step 1302, e.g. as described in relation to FIG. 5) and if speech recording is required (step 1303, e.g. as described in relation to FIG. 5). The reminder date/time (step 1304) and the reminder type (step 1305) are stored (e.g. as described above in relation to FIG. 9) and if speech recording is required (determined in step 1303), then a speech segment is recorded (step 1306). Based on all this stored information, the required reminder is then activated (step 1307) at the appropriate date/time.

FIG. 18 shows a schematic diagram of a suitable processor 1801 and an example of the connections required to determine whether two electrical connection points 1802, 1803 have been joined by way of a graphite (or conductive ink) track 1804. As described above, the resistance of the graphite mark (e.g. 20 k to 200 kohms) results in a large voltage drop and an analog input to the processor (e.g. AN3 in the example shown) may be used to read this voltage rather than a digital input.

The intelligent sticky note may be made from paper, plastic, cardboard or other suitable planar material with the electrical connections and other elements (e.g. processor, battery, LED etc) embedded within the material (e.g. sandwiched between two layers of the material) or otherwise held in/on the material. In an example, elements (such as the thicker elements) may be embedded partially in the material with a portion of the element (e.g. the top surface) remaining visible to the user (e.g. as with chip and pin style credit cards or other smart cards). In another example, some or all of the circuitry may be printed directly onto the substrate (e.g. the paper, plastic etc), for example using thin and flexible energy cells, such as those developed by Power Paper (trade mark) which are 1.5V cells and only 0.5 mm thick. A protective layer may be provided to cover the printed circuitry in some examples. The sticky note may have an adhesive portion (e.g. a strip) on the rear of the note for attachment to surfaces or may include one or more magnets or other attachment means. The intelligent sticky notes may be of similar size to standard sticky notes (e.g. of the order of a few centimeters on each side) and less than one millimeter thick. Similar manufacturing techniques may be used for other applications of the user interface described herein.

The intelligent sticky note described above may be disposable or may be re-usable. As described above, if a pencil is used to set the time/date etc via the user interface, the marks can be erased using a standard pencil eraser and new details may be entered. Where the note is disposable or is only re-used a small number of times, it may only require a battery with a short lifetime. The battery may be activated by the removal of the sticky note from the pad of sticky notes (e.g. by the removal process breaking a link in a track). In another example, the battery may be constantly charged whilst the sticky notes are held in a dispenser such that the power only starts being drained once the sticky note has been removed from the dispenser.

In another example application, the user interface described herein may be incorporated within a calendar such as a wall calendar to enable a user to set reminders for times on particular days. In an example, a clock face user interface may be included for each day on the calendar to allow a different time to be set for each day.

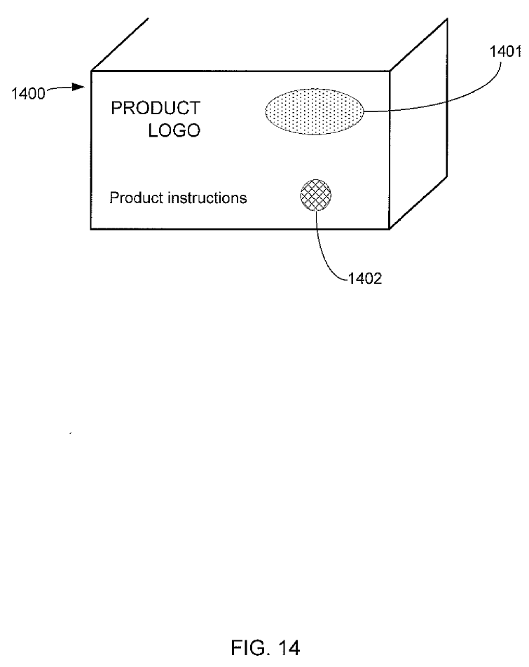

FIG. 14 shows a schematic diagram of intelligent packaging 1400 such as a box for tablets. The box includes a digital clock user interface 1401, as described above and shown in more detail in FIG. 4, and a reminder means 1402 such as a buzzer or LED. The associated electrical circuitry (which may be similar to that shown in FIG. 2 with the addition of a reminder means) including a processor and battery may be embedded within the packaging or printed onto the packaging as described above. A user may use the user interface to set the time that action is required relating to the contents of the packaging e.g. when the tablets should next be taken, the food should be put in or taken out of the oven etc. By using a pencil or other erasable conductive writing medium, the user interface may be re-used where reminders are required periodically (e.g. for tablets that should be taken three times a day at, for example, 08:00, 15:00 and 22:00). In another example, the user interface may be used to set an interval between reminders (e.g. 03:00 for reminders every 3 hours).

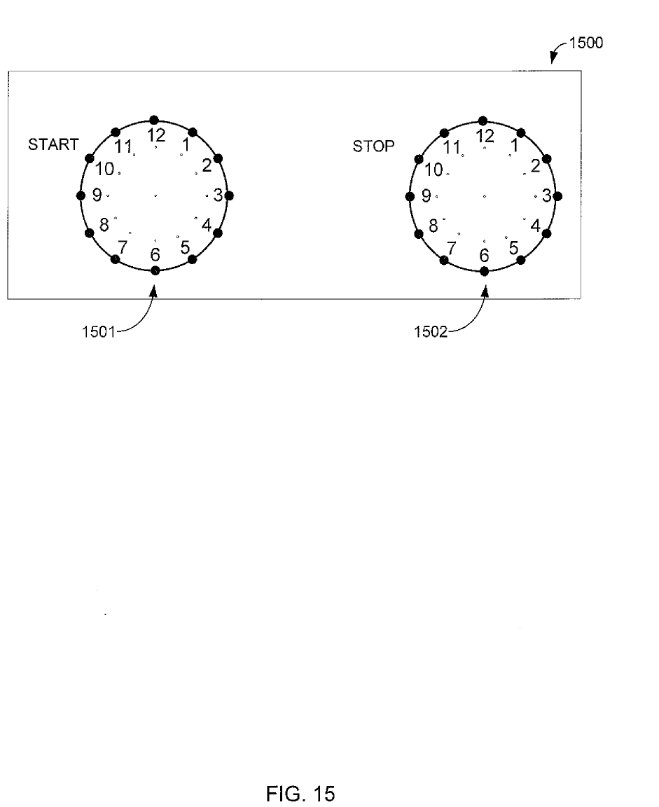

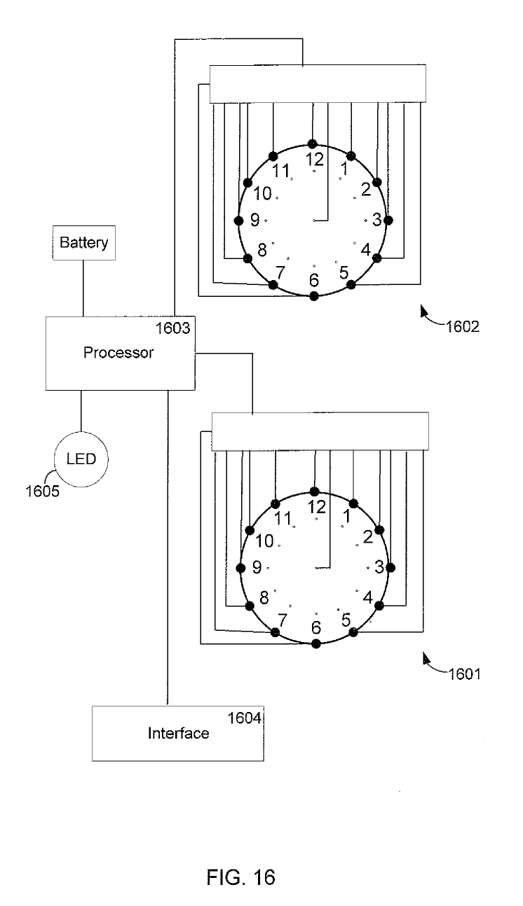

FIG. 15 shows a schematic diagram of a time clock interface 1500, e.g. for a heating system, video recorder etc. The interface includes two analog clock user interfaces 1501, 1502 to enable a user to set two different times, e.g. a start time and a stop time for an action such as heating or recording a television channel. FIG. 16 shows the corresponding circuit diagram which comprises two multiplexer—electrical connection arrangements 1601, 1602 one for each clock user interface (as described in more detail above and shown in FIGS. 1-3) connected to a processor 1603. The processor is powered by a battery 1604 and is also connected to a device interface 1604 which interfaces between the time clock interface 1500 and the device that it is controlling. The interface may be wireless (e.g. where the time clock interface is separate from the device) or may be wired (e.g. where the time clock interface is integrated with the device). The processor may also be connected to an LED 1605 (not shown in FIG. 15) which may be used to indicate when the device is active (e.g. when the video is recording or the heating on, i.e. at times between the start and the stop time) or to indicate when data is being transmitted via the interface 1604 to the device (not shown). At the times corresponding to those shown on each user interface, the user interface sends a signal to the device that it is controlling to initiate an action (e.g. stopping or starting a process such as heating or recording).

Although the examples described above include either an analog clock user interface (as shown in FIGS. 1-3) or a digital clock user interface (as shown in FIG. 4), it will be appreciated that those using an analog clock user interface could alternatively use a digital clock user interface and vice versa. Furthermore, in some examples, both an analog and a digital clock user interface may be provided and in such an example the user may have the choice between which user interface to use or the different user interfaces may be used for input of different parameters.

In the above examples, the user interfaces are used to indicate a time/date for a reminder and other information relating to that reminder. However, the user interfaces may alternatively be used to set a reminder using a parameter other than time (or in combination with a time/date). For example, the user interface may be used to set a temperature when an alert is required (e.g. using the seven segment user interface as shown in FIG. 4, a pattern arranged with graduations like a thermometer, a dial shaped user interface similar to the analog clock face etc) and the electrical circuit may include a temperature sensor connected to the processor. This may be useful in intelligent packaging where the contents of the packaging should not exceed a specified temperature (e.g. medication, food etc). The alert could be set to warn that the specified temperature is approaching so that action can be taken to protect the contents of the packaging. In other examples the parameter set may be in terms of altitude, humidity, pressure, and location (e.g. where the user interface has a wireless link to a GPS device) etc.

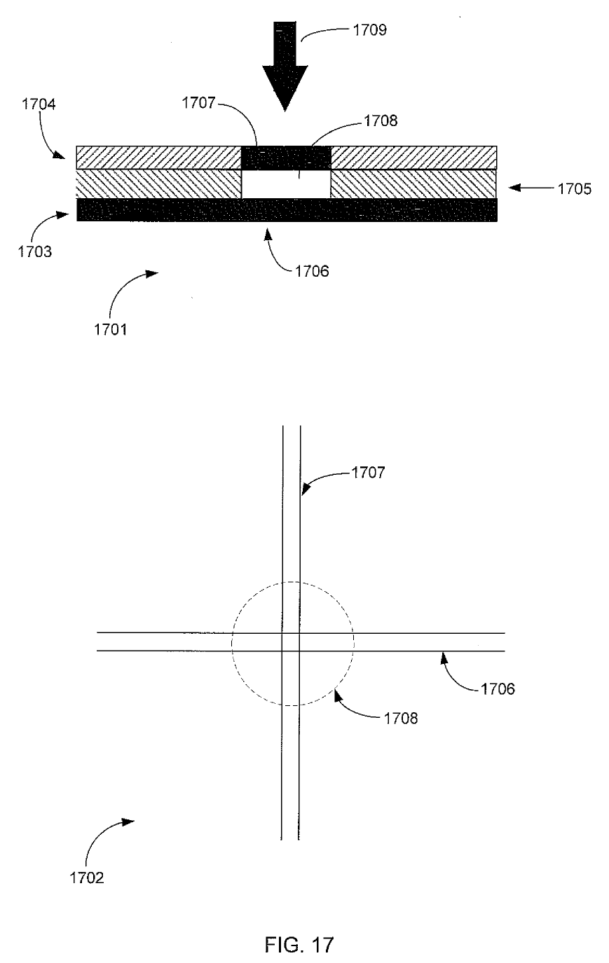

Although the above description relates to user interfaces in which the lines drawn are electrically conductive and the time (or other parameter) is set by drawing lines joining electrical connection points, the user interface may alternatively be touch sensitive such that any writing implement may be used (e.g. a pen). Such a user interface may be manufactured using the same or similar technology as that used for membrane keyboards. FIG. 17 is a schematic diagram of part of a touch sensitive user interface and shows a side view 1701 and a top view 1702. Electrical contacts are produced on two layers 1703, 1704 which are separated by a spacer layer 1705. The spacer layer is not a complete layer but has holes 1708 which correspond to the crossing points of electrical tracks 1706, 1707 within the layers such that when pressure is applied above the hole 1708 (as shown by arrow 1709) the two electrical tracks 1706, 1707 are brought into contact. As the tracks 1706, 1707 do not remain in contact once pressure is released, latches are required within the electrical circuit to maintain the information relating to the electrical connections made. The user interface may be set using items other than a writing implement (e.g. the user's finger, a stylus etc) however if this is done, there is no visual reminder of the time set unless additional feedback means are provided (e.g. an LCD display). To re-use the interface, a reset button may be included within the user interface and any lines drawn may need to be erasable.

In some examples, some elements of the user interface may be touch sensitive and some elements may rely on the creation of electrical paths between electrical connection points. For example, a touch sensitive button may be provided to cancel the reminder (e.g. to stop the buzzer, flashing LED etc) or to reset the reminder (e.g. where the user interface indicates an interval rather than a specific time or where the reminder is required on several days), whilst the reminder time is set by drawing lines (e.g. hands) on a clock face (analog or digital) using a pencil or pen with conductive ink.

As described above, any aspects of any of the examples provided above may be combined in any manner with aspects of other examples provided above.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person. It will be appreciated that any reference to “an” item or “a” thing is intended to encompass a reference to one or more of such items or things.

The steps of the methods described herein may be carried out in any suitable order, or simultaneously where appropriate.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A user interface comprising:
a plurality of exposed electrical connections arranged in a pattern on a writing surface;
wherein each of the plurality of exposed electrical connections can be electrically connected to another of the plurality of exposed electrical connections by a line drawn on the writing surface in an electrically conductive writing medium.

2. A user interface according to claim 1, wherein the electrically conductive writing medium comprises graphite.

3. A user interface according to claim 1, further comprising a processor coupled to the plurality of exposed electrical connections and arranged to:
detect if any of the plurality of exposed electrical connections are electrically connected together.

4. A user interface according to claim 3, wherein the processor is further arranged to:
initiate an action determined by which of the plurality of exposed electrical connections are electrically connected together.

5. A user interface according to claim 4, wherein a time is indicated by which of the plurality of exposed electrical connections are electrically connected together.

6. A user interface according to claim 4, wherein one of a temperature, a pressure, an altitude, a humidity and a location is indicated by which of the plurality of exposed electrical connections are electrically connected together.

7. A user interface according to claim 4, further comprising a reminder means, and wherein the action comprises activating the reminder means.

8. A user interface according to claim 7, wherein the reminder means comprises one of: an LED and a loudspeaker.

9. A user interface according to claim 3, wherein the processor is embedded within the writing surface.

10. A user interface according to claim 1, wherein the user interface further comprises a clock face printed on the writing surface and wherein a first subset of the plurality of exposed electrical connections are arranged around the circumference of the clock face.

11. A user interface according to claim 10, wherein the first subset comprises all of the plurality of exposed electrical connection.

12. A user interface according to claim 10, wherein a second subset of the plurality of exposed electrical connections arranged around the circumference of a circle, the circle and the clock face being concentric.

13. A user interface according to claim 1, wherein the user interface further comprises:
a calendar grid printed on the writing surface, the calendar grid having two perpendicular axes; and
wherein a subset of the plurality of exposed electrical connections are arranged in lines, each line being parallel to one of the axes of the grid.

14. A user interface according to claim 13, wherein the subset comprises all of the plurality of exposed electrical connections.

15. A sticky note comprising:
a planar material having a writing surface on one side and an attachment means on an opposite side; and
a plurality of exposed electrical connections arranged in a pattern on the writing surface;
wherein each of the plurality of exposed electrical connections can be electrically connected to another of the plurality of exposed electrical connections by a line drawn on the writing surface in an electrically conductive writing medium.

16. A sticky note according to claim 15, further comprising:
a reminder means; and
a processor coupled to the plurality of exposed electrical connections and arranged to:
detect if any of the plurality of exposed electrical connections are electrically connected together; and
activate the reminder means at an instant determined by which of the plurality of exposed electrical connections are electrically connected together.

17. A sticky note according to claim 16, further comprising:
a wireless interface for communication with a computer.

18. A sticky note according to claim 16, wherein the reminder means comprises a loudspeaker and further comprising:
a microphone; and
a speech recording module.

19. A sticky note according to claim 15, further comprising:
a message region on the writing surface.

20. A box comprising:
a writing region on a side of the box; and
a plurality of exposed electrical connections arranged in a pattern on the writing region;
wherein each of the plurality of exposed electrical connections can be electrically connected to another of the plurality of exposed electrical connections by a line drawn on the writing surface in an electrically conductive writing medium.
